(19) United States
(12) Patent Application Publication
(10) Pub. No.: US 2023/0078287 A1
(43) Pub. Date: Mar. 16, 2023

(54) HYDROGEN SUPPLY NETWORK MANAGEMENT OPTIMIZATION PLATFORM AND METHOD THEREFOR

(71) Applicant: HYUNDAI GLOVIS CO., LTD., Seoul (KR)

(72) Inventors: Sangwoo NAM, Daejeon (KR); Gyusik JEON, Suwon-si, Gyeonggi-do (KR); Munbeom SONG, Suwon-si, Gyeonggi-do (KR)

(21) Appl. No.: 17/904,545

(22) PCT Filed: Aug. 19, 2021
(86) PCT No.: PCT/KR2021/011004

§ 371 Date: Aug. 18, 2022

(30) Foreign Application Priority Data
Sep. 4, 2020 (KR) 10-2020-0113108
May 31, 2021 (KR) 10-2021-0070079

(51) Int. Cl. G06Q 10/04; G06Q 10/06; G06Q 10/08; G06Q 50/28; G06Q 50/30

(52) U.S. Cl. CPC G06Q 10/04; G06Q 10/06; G06Q 10/08; G06Q 50/28; G06Q 50/30

(57) ABSTRACT

A fuel supply network management system according to one embodiment of the present document can comprise: an information acquisition unit for acquiring operation information about a charging station and operation information about a shipping center; a charging station management unit for monitoring the charging station on the basis of the operation information about the charging station, and predicting the demand for fuel provided by the charging station; and a shipping management unit for managing a fuel supply network between the charging station and the shipping center on the basis of at least one from among the operation information about the charging station, the operation information about the shipping center and demand prediction information about the charging station.

### CROSS REFERENCE TO RELATED APPLICATIONS

This application is a national phase application, filed under 35 U.S.C. § 371, of International Patent Application No. PCT/KR2021/011004, filed on Aug. 19, 2021, which claims the benefit of a Korean Patent Application No. 10-2020-0113108, filed on Sep. 4, 2020, and Korean Patent Application No. 10-2021-0070079, filed on May 31, 2021, the contents of which are incorporated by reference herein in their entirety.

### FIELD OF THE DISCLOSURE

Embodiments of the present disclosure relate to a system and a method for managing a fuel supply chain.

### BACKGROUND

Today, as an importance of environmental protection is emphasized, while regulations on existing fossil fuels are being strengthened, businesses related to new and renewable energy such as solar power, wind power, hydro power, a fuel cell, and the like are gradually increasing. Above all, in particular, in a case of an automobile industry, electric vehicles and hydrogen vehicles are in the spotlight instead of conventional internal combustion engines.

In a case of such hydrogen fuel, rather than supplying the hydrogen fuel to a storage space of a refueling station in a state of being stored in a transportation tank like existing liquefied natural gas (LNG), a scheme of replacing a tube trailer itself for storing and transporting hydrogen is being utilized. As such, a tube trailer in which the hydrogen is fully refueled is required to replace a tube trailer at a refueling station at an optimal time.

However, at present, because the number of tube trailers operated and facilities of a shipping center are finite, it is difficult to apply a general logistics process of fully refueling the hydrogen in advance, holding the hydrogen in stock, and supplying the hydrogen immediately whenever necessary. In addition, systems of process regions in a supply chain management (SCM) of the hydrogen are different from each other, and an interface (I/F) of information does not work properly, so that there is a limit to formation of a smooth hydrogen supply system. In addition, it is impossible to monitor overall operation, such as a consumption, a remaining amount, a demand prediction, a tube trailer replacement time, a vehicle dispatch status, and the like of the hydrogen refueling station, and it is impossible to immediately identify an occurrence of an issue such as a transportation accident and the like.

### BRIEF DESCRIPTION OF THE INVENTION

Embodiments disclosed in the present disclosure are to provide a system and a method for managing a fuel supply chain that monitor an entire region of a hydrogen supply chain and implement an optimized system through optimal logic application, thereby monitoring a consumption, a supply cycle, a remaining amount, a demand prediction, and the like of a refueling station in real time, performing stable operation and supply and demand management with easy access to transportation information, and performing efficient refueling and vehicle dispatch tasks based on information such as a consumption, a demand prediction, and an operation status of tube trailers, and the like of each refueling station.

The technical problems to be solved by the present inventive concept are not limited to the aforementioned problems, and any other technical problems not mentioned herein will be clearly understood from the following description by those skilled in the art to which the present disclosure pertains.

### DETAILED DESCRIPTION OF THE INVENTION

A system for managing a fuel supply chain according to one embodiment of the present disclosure includes an information acquisition device that acquires operation information of a refueling station and operation information of a shipping center, a refueling station management device that monitors the refueling station based on the operation information of the refueling station, and predicts a demand for fuel provided by the refueling station, and a shipment management device that manages the fuel supply chain between the refueling station and the shipping center based on at least one of the operation information of the refueling station, the operation information of the shipping center, or demand prediction information of the refueling station.

According to one embodiment, the refueling station management device may predict the demand for the fuel of the refueling station based on a consumption pattern for the fuel of the refueling station.

According to one embodiment, the refueling station management device may provide at least one of information on a vehicle dispatch status of transportation means for transporting the fuel, a real-time location of the transportation means, or an expected arrival time of the transportation means to the refueling station.

According to one embodiment, the refueling station management device may automatically generate order information on transportation of the fuel based on the demand prediction information on the fuel of the refueling station.

According to one embodiment, the shipment management device may allocate a shipping center capable of transporting the fuel to each refueling station based on the operation information of the refueling station, the operation information of the shipping center, and the demand prediction information of the refueling station.

According to one embodiment, the shipment management device may create a schedule for transportation of the fuel.

According to one embodiment, the schedule for the transportation of the fuel may include information on allocation and vehicle dispatch schedules of transportation means for transporting the fuel.

According to one embodiment, the shipment management device may generate refueling schedule information on transportation means of the fuel equipped in the shipping center.

According to one embodiment, the shipment management device may provide information on at least one of a consumption, a remaining amount, a demand prediction, or a replacement time of the fuel of each refueling station to the shipping center.

According to one embodiment, the shipment management device may generate settlement information on transportation of the fuel based on actual transportation information of the fuel.

According to one embodiment, the shipment management device may provide information on a travel route of transportation means for transporting the fuel calculated based on real-time traffic information to the shipping center.

According to one embodiment, the shipment management device may perform monitoring on a refueling state of transportation means of the fuel equipped in the shipping center.

According to one embodiment, the operation information of the refueling station may include at least one of a usage of the fuel for each period, a remaining amount of the fuel, a replacement history of the fuel, operating hours, or location information of the refueling station.

According to one embodiment, the operation information of the shipping center may include at least one of a supply amount for each period of the shipping center, operation information on transportation means of the fuel, a supply cycle of each refueling station, or location information of the shipping center.

According to one embodiment, the shipment management device may create a transportation schedule based on information on a supply amount of the fuel of the shipping center, the number of refueling nozzles equipped in the shipping center, a pressure of the refueling nozzle, the number of fuel transportation means, and a capacity of transportation means, and information on operating hours, a distance to the shipping center, and an average travel time to the shipping center of the refueling station.

According to one embodiment, the fuel may include hydrogen in a form of at least one of gas, liquid, or liquid organic hydrogen carriers (LOHC).

A method for managing a fuel supply chain according to an embodiment of the present disclosure includes acquiring operation information of a refueling station and operation information of a shipping center, monitoring the refueling station based on the operation information of the refueling station, and predicting a demand for fuel provided by the refueling station, and managing the fuel supply chain between the refueling station and the shipping center based on at least one of the operation information of the refueling station, the operation information of the shipping center, or demand prediction information of the refueling station.

The system and the method for managing the fuel supply chain according to an embodiment disclosed in the present disclosure monitor the entire region of the hydrogen supply chain and implement the optimized system through the optimal logic application, thereby monitoring the consumption, the supply cycle, the remaining amount, the demand prediction, and the like of the refueling station in real time, performing the stable operation and the supply and demand management with the easy access to the transportation information, and performing the efficient refueling and vehicle dispatch tasks based on the information such as the consumption, the demand prediction, and the operation status of the tube trailers, and the like of each refueling station.

### BRIEF DESCRIPTION OF THE DRAWINGS

FIG. 1 is a view for illustrating that a fuel supply chain management system according to an embodiment disclosed in the present disclosure operates with a refueling station and a shipping center.

FIG. 2 is a block diagram showing a configuration of a fuel supply chain management system according to an embodiment disclosed in the present disclosure.

FIG. 3 is a view for illustrating an operation process of a fuel supply chain management system according to an embodiment disclosed in the present disclosure.

FIG. 4 is a view for illustrating an order management operation of a fuel supply chain management system according to an embodiment disclosed in the present disclosure.

FIG. 5 is a view for illustrating a vehicle dispatch management operation of a fuel supply chain management system according to an embodiment disclosed in the present disclosure.

FIG. 6 is a view for illustratively describing a matching operation of a refueling station and a shipping center of a fuel supply chain management system according to an embodiment disclosed in the present disclosure.

FIG. 7 is a flowchart showing a fuel supply chain management method according to an embodiment disclosed in the present disclosure.

### DETAILED DESCRIPTION OF THE DRAWINGS

Hereinafter, various embodiments disclosed in the present disclosure will be described in detail with reference to the accompanying drawings. In the present disclosure, the same reference numerals are used for the same components in the drawings, and duplicate descriptions of the same components are omitted.

For the various embodiments disclosed in the present disclosure, specific structural or functional descriptions are only illustrated for the purpose of describing the embodiments. Various embodiments disclosed in the present disclosure may be implemented in various forms and should not be construed as being limited to the embodiments described in the present disclosure.

Expressions such as “first”, “second”, and the like used in various embodiments may modify various components regardless of order and/or importance, and may not limit the corresponding components. For example, without departing from the scope of the embodiment disclosed in the present disclosure, a first component may be named as a second component, and similarly, the second component may also be renamed as the first component.

Terms used in the present disclosure are only used to describe specific embodiments, and may not be intended to limit the scope of other embodiments. The singular expression may include the plural expression unless the context clearly dictates otherwise.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, even terms defined in the present disclosure are not able to be construed to exclude the embodiments disclosed in the present disclosure.

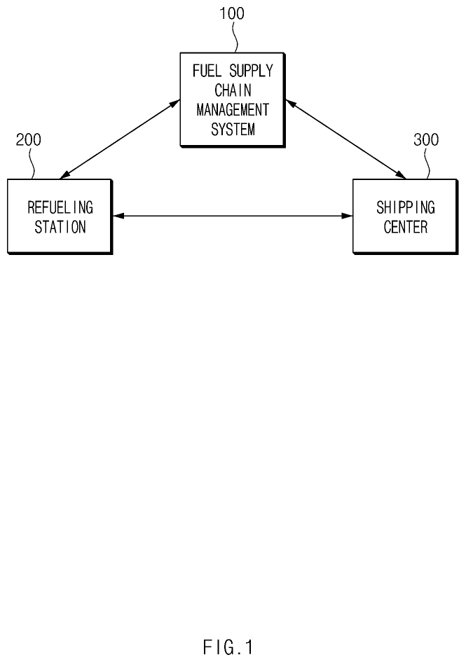

FIG. 1 is a view for illustrating that a fuel supply chain management system according to an embodiment disclosed in the present disclosure operates with a refueling station and a shipping center.

Referring to FIG. 1, a fuel supply chain management system 100 according to an embodiment disclosed in the present disclosure may communicate with a refueling station 200 and a shipping center 300 located in all places. In this connection, the fuel supply chain management system 100 may communicate with the refueling station 200 and the shipping center 300 directly through a network, or through an intermediary server (not shown).

The fuel supply chain management system 100 according to an embodiment disclosed in the present disclosure may collect various data from the refueling station 200 and the shipping center 300, and perform overall monitoring and management tasks through operation algorithm based on the collected data.

The fuel supply chain management system 100 may predict a demand for a fuel based on a fuel consumption pattern of the refueling station 200 and perform an automatic order. In addition, the fuel supply chain management system 100 may create a refueling scheduling of the shipping center 300 based on the demand prediction data of the refueling station 200 to calculate a required shipment amount (e.g., the number of tube trailers required to be shipped) for each day/time.

As such, the fuel supply chain management system 100 may select the refueling station 200 that requires fuel replacement, and create an optimal matching and a vehicle dispatch schedule between the refueling station 200 and the shipping center 300 based on a replacement required time, location data, and the like of the corresponding refueling station 200, and fully refueled and waiting states, the number, a shipping available time, location data, and the like of tube trailers of the shipping center 300.

In addition, the fuel supply chain management system 100 may perform operation and inventory management tasks of the tube trailers. For example, the fuel supply chain management system 100 may perform the inventory management for each state (e.g., refueled, waiting, and in transit) of the tube trailer and each location (a vehicle, the refueling station 200, the shipping center 300, and the like), and may allocate an empty tube trailer to the shipping center 300 or manage a key value of the tube trailer.

Specifically, the fuel supply chain management system 100 may perform monitoring on a status such as a tube trailer refueling status of the shipping center 300, a fuel consumption, a remaining amount, a predicted consumption, and an order status of each refueling station 200, a vehicle dispatch status and a vehicle location of transportation vehicles, and an inventory, a location, and a state of the tube trailer. In addition, the fuel supply chain management system 100 may perform basic information management of information of the refueling station 200, information of the shipping center 300, information on the transportation vehicles and drivers, and the like.

In addition, the fuel supply chain management system 100 may perform management of the shipping center 300 such as the refueling, scheduling of the tube trailer, the inventory management (e.g., fully refueled, being refueled, and waiting) of the tube trailer, warehousing/withdrawal management of the tube trailer of the shipping center 300. In addition, the fuel supply chain management system 100 may perform a transportation management function such as vehicle dispatch scheduling and routing of the transportation vehicles (e.g., locations of the refueling station 200 and the shipping center 300 in a limited region, a time it takes to fully refueling the tube trailer, and matching and vehicle dispatching between the vehicle and the tube trailer in consideration of a replacement time of the refueling station 200), real-time vehicle and tube trailer location tracking, tube trailer recovery management, and the like.

In addition, the fuel supply chain management system 100 may perform order and overall management functions of the refueling station 200 such as the automatic order in consideration of the remaining amount, the consumption, and the replacement time of the refueling station 200, rule management of the automatic order, order state management, the demand prediction based on the consumption pattern of the refueling station 200, management of warehousing/withdrawal and replacement history of the tube trailer (that is, replacement between a fully refueled tube trailer and the empty tube trailer), and the like.

In addition, the fuel supply chain management system 100 may perform settlement management tasks such as aggregation and settlement of order types (e.g., transportation, distribution, and transportation/distribution), sales settlement management, settlement transmission and sales transaction statement issuance, purchase settlement transmission, purchase transaction statement issuance, and the like of the refueling station 200.

In one example, the fuel supply chain management system 100 may create an optimal matching and vehicle dispatch schedule between the refueling station 200 and the shipping center 300 based on a location and a state (e.g., driving and waiting) of the transportation vehicle, the location and the state (e.g., being refueled and in transit) of the tube trailer, real-time traffic information, average travel time of the vehicle, vehicle dispatch information, and the like to perform regional shuttle-type transportation scheduling through linkage of information on the location of the refueling station 200, the vehicle location, and the location of the shipping center 300. In addition, the fuel supply chain management system 100 may be in association with a UPS to track the locations of the transportation vehicle and the tube trailer in real time and perform comprehensive control monitoring.

The refueling station 200 may transmit various data on the fuel demand to the fuel supply chain management system 100. For example, the refueling station 200 may transmit data such as a daily/weekly/monthly fuel usage (or sales volume), a real-time fuel remaining amount in the tube trailer, operating hours (e.g., a peak time, a vehicle waiting time, and the like), the replacement history (a cycle, the number for each month, and the like) of the tube trailer, location information for each refueling station 200, and the like to the fuel supply chain management system 100.

As such, the fuel supply chain management system 100 may perform monitoring and management functions of the demand prediction (or replacement time prediction) based on the consumption pattern, the automatic order based on the fuel remaining amount of fuel/lead time/replacement time, the vehicle dispatch status of the transportation vehicles, real-time vehicle location information, expected arrival time information, and the like based on the data received from the refueling station 200.

The shipping center 300 may transmit various data on a shipping status of the fuel to the fuel supply chain management system 100. For example, the shipping center 300 may transmit a daily/weekly/monthly shipping amount (or supply amount), operation information (being refueled and waiting) of the tube trailer, a refueling time of the tube trailer, a supply cycle of each refueling station 200, location information of each shipping center 300, and the like to the fuel supply chain management system 100.

As such, the fuel supply chain management system 100 may perform functions such as the monitoring of the refueling status of the tube trailer in the shipping center 300, prediction of a supply amount and a supply time of each refueling station 200, refueling operation scheduling based on prediction information (e.g., information on tube trailers required to be refueled or shipped for each day/time), creation of settlement data based on an actual transportation volume, and the like based on the data received from the shipping center 300.

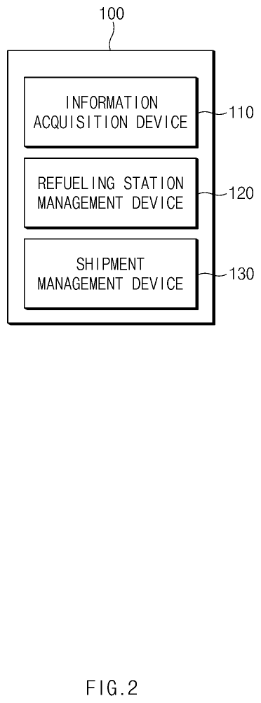

FIG. 2 is a block diagram showing a configuration of a fuel supply chain management system according to an embodiment disclosed in the present disclosure.

Referring to FIG. 2, the fuel supply chain management system 100 according to an embodiment disclosed in the present disclosure may include an information acquisition device 110, a refueling station management device 120, and a shipment management device 130.

The information acquisition device 110 may acquire operation information of the refueling station 200 and operation information of the shipping center 300. For example, the operation information of the refueling station 200 may include a usage of the fuel for each period, the remaining amount of the fuel, the fuel replacement history, the operating hours, the location information, and the like of the refueling station 200. In addition, the operation information of the shipping center 300 may include a supply amount for each period of the shipping center 300, operation information on transportation means of the fuel, the supply cycle of each refueling station, the location information, and the like of the shipping center 300. For example, the fuel may include hydrogen in a form of gas, liquid, liquid organic hydrogen carriers (LOHC), and the like.

The refueling station management device 120 may perform monitoring on the refueling station based on the operation information of the refueling station 200, and predict the demand for the fuel provided by the refueling station 200. Specifically, the refueling station management device 120 may predict the demand for the fuel of the refueling station 200 based on the consumption pattern of the fuel of the refueling station 200. In addition, the refueling station management device 120 may provide information on a vehicle dispatch status of the transportation means for transporting the fuel, a real-time location of the transportation means, and an expected arrival time of the transportation means to the refueling station 200.

The refueling station management device 120 may automatically generate order information on the transportation of the fuel based on the demand prediction information on the fuel of the refueling station 200. That is, in the fuel supply chain management system 100 according to an embodiment disclosed in the present disclosure, the refueling station management device 120 may estimate the replacement time and quantity based on the demand prediction information calculated based on the fuel usage, the remaining amount, and the like of the refueling station 200, and perform the automatic order even when an operator of the refueling station 200 does not place an order by himself.

The shipment management device 130 may manage a fuel supply chain between the refueling station 200 and the shipping center 300 based on at least one of the operation information of the refueling station 200, the operation information of the shipping center 300, or the demand prediction information of the refueling station 200. For example, the shipment management device 130 may allocate the shipping center 300 capable of transporting the fuel to each refueling station 200 based on the operation information of the refueling station 200, the operation information of the shipping center 300, and the demand prediction information of the refueling station 200.

In addition, the shipment management device 130 may create a schedule on the transportation of the fuel. In this connection, the schedule on the transportation of the fuel may include information on allocation and vehicle dispatch schedules of the transportation means for transporting the fuel. For example, the shipment management device 130 may create the fuel transportation schedule based on information on the supply amount of the fuel of the shipping center 300, the number of refueling nozzles equipped in the shipping center 300, a pressure of the refueling nozzle, the number of fuel transportation means, and a capacity of the transportation means, and information on the operating hours of the refueling station 200, a distance to the shipping center 300 from the refueling station 200, and an average travel time to the shipping center from the refueling station 200.

In addition, the shipment management device 130 may create refueling schedule information on the transportation means of the fuel equipped in the shipping center 300. Accordingly, the shipment management device 130 may allow a manager of the shipping center 300 to perform refueling of the transportation means (e.g., the tube trailer) based on the refueling schedule information.

The shipment management device 130 may provide the information on the consumption, the remaining amount, the demand prediction, the replacement time, and the like of the fuel of each refueling station 200 to the shipping center 300. In addition, the shipment management device 130 may provide information on a travel route of the transportation means calculated based on the real-time traffic information to the shipping center 300. In addition, the shipment management device 130 may perform monitoring on a refueling state of the transportation means of the fuel equipped in the shipping center 300.

In one example, the shipment management device 130 may generate settlement information on the transportation of the fuel based on actual transportation information of the fuel. For example, the shipment management device 130 may generate the settlement information that includes a supply amount of the fuel, a transportation means usage fee, and the like, and is about a corresponding transportation case.

As such, the fuel supply chain management system 100 according to an embodiment disclosed in the present disclosure monitors an entire region of the hydrogen supply chain and implements an optimized system through optimal logic application, thereby monitoring the consumption, the supply cycle, the remaining amount, the demand prediction, and the like of the refueling station 200 in real time, performing stable operation and supply and demand management with easy access to the transportation information, and performing efficient refueling and vehicle dispatch tasks based on information such as the consumption, the demand prediction, and an operation status of the tube trailers, and the like of each refueling station 200.

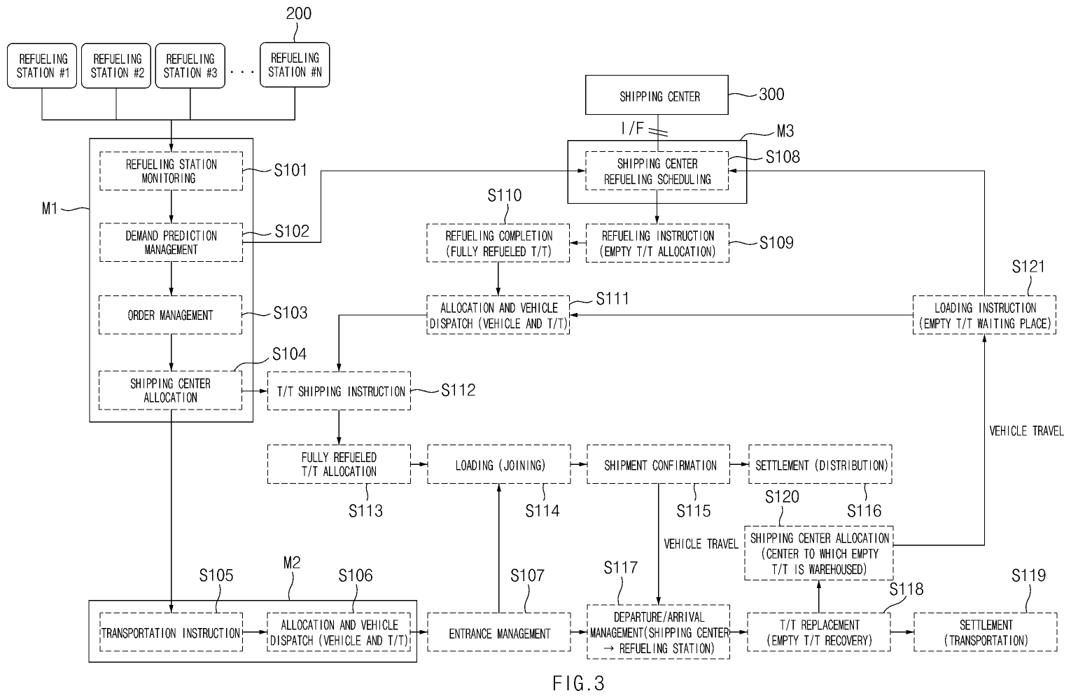

FIG. 3 is a view for illustrating an operation process of a fuel supply chain management system according to an embodiment disclosed in the present disclosure.

Referring to FIG. 3, the fuel supply chain management system 100 according to an embodiment disclosed in the present disclosure may collect data on the operation information of the refueling station 200 from the refueling station 200 located in each region to perform the monitoring of the refueling station 200 (S101). In particular, the fuel supply chain management system 100 may perform demand prediction management for each refueling station 200 based on the operation information of the refueling station 200 (S102).

In addition, the fuel supply chain management system 100 may automatically place the order even when the operator of the refueling station 200 does not place the order by himself based on the fuel consumption, the remaining amount, the demand prediction, and the like of each refueling station 200 (S103). In addition, the fuel supply chain management system 100 may allocate an optimal shipping center 300 to each refueling station 200 based on the location of the refueling station 200, the location of the shipping center 300, the location information of the tube trailer and the transportation vehicle, the demand prediction of the refueling station 200, the refueling status of the shipping center 300, and the like (S104).

As such, the fuel supply chain management system 100 according to one embodiment disclosed in the present disclosure may perform an order management function M1 for the refueling station 200 through operations S101 to S104 described above.

In addition, the fuel supply chain management system 100 may transmit, to the allocated shipping center 300, an instruction for transportation to the refueling station 200 (S105). In addition, the fuel supply chain management system 100 may allocate and dispatch the vehicle and the tube trailer in consideration of the location, the refueling status, and the like of each of the transportation vehicle and the tube trailer (S106). In addition, the fuel supply chain management system 100 may perform an entrance management task for the transportation vehicle and the tube trailer (S107).

As such, the fuel supply chain management system 100 according to an embodiment disclosed in the present disclosure may perform an allocation and vehicle dispatch management function M2 for the transportation means for the refueling station 200 through operations S105 to S106 described above.

In one example, refueling scheduling of the shipping center 300 may be performed by collecting the operation information from the shipping center 300 of the fuel supply chain management system 100 (S108). That is, the fuel supply chain management system 100 may create a refueling schedule for each tube trailer by monitoring the refueling status (e.g., fully refueled, being refueled, and not refueled) of each tube trailer equipped in the shipping center 300 (M3).

Next, the fuel supply chain management system 100 may transmit a refueling instruction by allocating the empty tube trailer that is not refueled (S109), and allow all the tube trailers to be fully refueled (S110). As such, the fuel supply chain management system 100 may manage the inventory based on the state of the tube trailer equipped in the shipping center 300 based on the refueling status (fully refueled/being refueled/not refueled) of each tube trailer (S111). In addition, when the fuel supply chain management system 100 transmits an instruction for the shipment of the tube trailer (S112), the shipping center 300 may allocate the fully refueled tube trailer.

In addition, the shipping center 300 may load (join) the allocated tube trailer to the transportation vehicle (S114), and confirm shipment when shipment preparation is completed (S115). As such, when the shipment is confirmed, the fuel supply chain management system 100 may perform settlement of a corresponding distribution case of the fuel (S116).

In one example, after the shipment is confirmed, the fuel supply chain management system 100 may perform management on whether the transportation vehicle and the tube trailer have arrived the refueling station 200 after departing from the shipping center 300 (S117). For example, the fuel supply chain management system 100 may identify the real-time location of the transportation vehicle and the tube trailer to provide information such as the real-time location, the expected arrival time, and the like to the refueling station 200 and the shipping center 300. In addition, when the transportation vehicle and the tube trailer arrive at the refueling station 200, a used tube trailer may be recovered after being replaced with the corresponding tube trailer (S118). In addition, the fuel supply chain management system 100 may perform the settlement of the corresponding transportation case when the replacement and the recovery of the tube trailer are completed (S119).

In addition, after allocating the shipping center 300 for warehousing the recovered tube trailer (S120), the fuel supply chain management system 100 may allow the corresponding tube trailer to wait at a waiting place, and then transmit a warehousing instruction when preparation for loading is completed (S121). As such, the fuel supply chain management system 100 may warehouse the recovered tube trailer into the shipping center 300 again, and then, create the refueling scheduling such that the recovered tube trailer is refueled again.

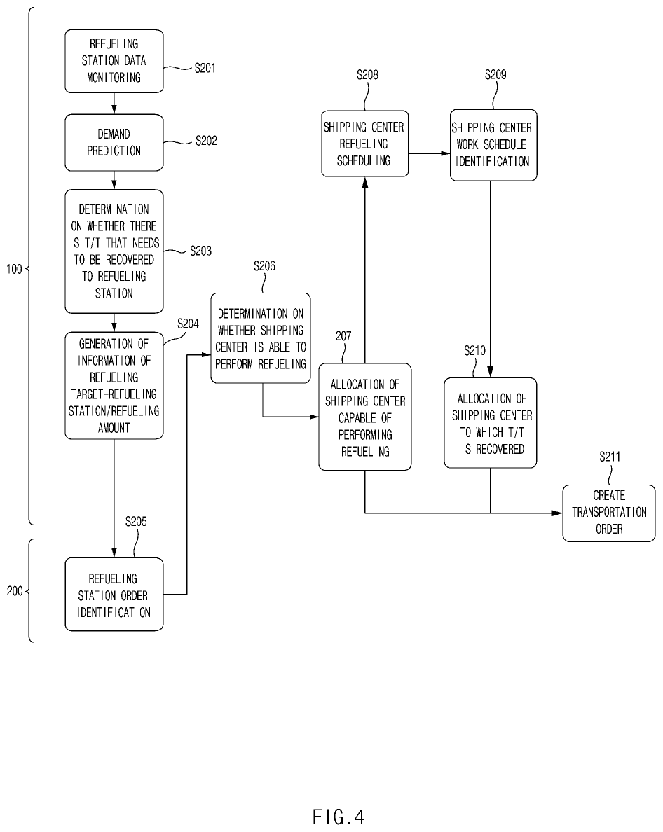

FIG. 4 is a view for illustrating an order management operation of a fuel supply chain management system according to an embodiment disclosed in the present disclosure.

Referring to FIG. 4, the fuel supply chain management system 100 according to an embodiment disclosed in the present disclosure may monitor the operation information data of the refueling station 200 first when managing the order (S201). In this connection, the fuel supply chain management system 100 may monitor an amount of hydrogen demand for each refueling station 200. For example, the fuel supply chain management system 100 may perform monitoring based on hydrogen refueling time and consumption for each unit sales, and the current remaining amount of the hydrogen in the tube trailer of the refueling station 200.

In addition, the fuel supply chain management system 100 may predict the amount of hydrogen demand for each refueling station (S202). For example, the fuel supply chain management system 100 may predict the replacement time based on a past performance of the corresponding charging station, or predict a hydrogen replacement required time of the refueling station 200 through separate algorithm. In addition, the fuel supply chain management system 100 may determine whether currently there is a tube trailer that needs to be replaced (that is, a tube trailer to be recovered) in the refueling station 200 (S203).

Next, the fuel supply chain management system 100 may generate information of a target refueling station requiring the replacement of the tube trailer and a refueling amount (S204). For example, the fuel supply chain management system 100 may generate the location information of the refueling station 200 requiring the replacement of the tube trailer and information on a required amount of refueling based on a capacity of each tube trailer.

In one example, the refueling station 200 may receive the information on the replacement target refueling station and the refueling amount by the fuel supply chain management system 100, and identify an order for the corresponding refueling station and refueling amount (S205). For example, it may be set that a next process is performed when a manager of the refueling station 200 finally identifies the order for the refueling.

As such, when the final identification on the refueling order is completed in the refueling station 200, the fuel supply chain management system 100 may determine whether the refueling of the corresponding refueling station 200 is possible for each shipping center 300 (S206). In this case, the fuel supply chain management system 100 may select a place where the full refueling of the tube trailer is possible at the shipping center 300 located in each region, and identify the number of nozzles for the refueling of the corresponding shipping center 300.

In addition, the fuel supply chain management system 100 may allocate the shipping center 300 capable of the refueling to the replacement target refueling station 200 (S207). In this connection, the fuel supply chain management system 100 may allocate the optimal shipping center 300 matching each refueling station 200 based on the data such as the locations of the refueling station 200 and the shipping center 300, the refueling status of the tube trailer, and the like.

In addition, the fuel supply chain management system 100 may perform the refueling scheduling of the tube trailer for the allocated shipping center 300 (S208). For example, the fuel supply chain management system 100 may consider a total supply amount (pressure) of the hydrogen, the number of refueling nozzles in the shipping center 300, a pressure of each nozzle, the number of connected tube trailers, and the like in terms of the shipping center 300 at the time of the refueling scheduling, and consider a storage capacity (pressure) of each tube trailer and the number of operated tube trailers in terms of the tube trailers. In addition, in terms of the refueling station 200 (a source of demand) during the refueling scheduling, the fuel supply chain management system 100 may perform the refueling scheduling in consideration of factors such as the operating hours of the refueling station 200, the distance to the shipping center 300, the average travel time of the transportation vehicle, whether the tube trailer is malfunctioning, and the like.

In addition, the fuel supply chain management system 100 may identify a work schedule of each shipping center 300 (S209). For example, the fuel supply chain management system 100 may identify whether the fully refueled tube trailer is in stock, a shipping available time, and the like for each shipping center 300. In addition, the fuel supply chain management system 100 may allocate the shipping center 300 to which the tube trailer recovered after being used at each refueling station 200 is to be transported in consideration of the work schedule of each shipping center 300 (S210).

As such, the fuel supply chain management system 100 may allocate the shipping center 300 for the refueling in operation S207, or, after allocating the shipping center 300 to recover the tube trailer in operation S210, may create an order for the corresponding transportation case and perform the settlement (S211).

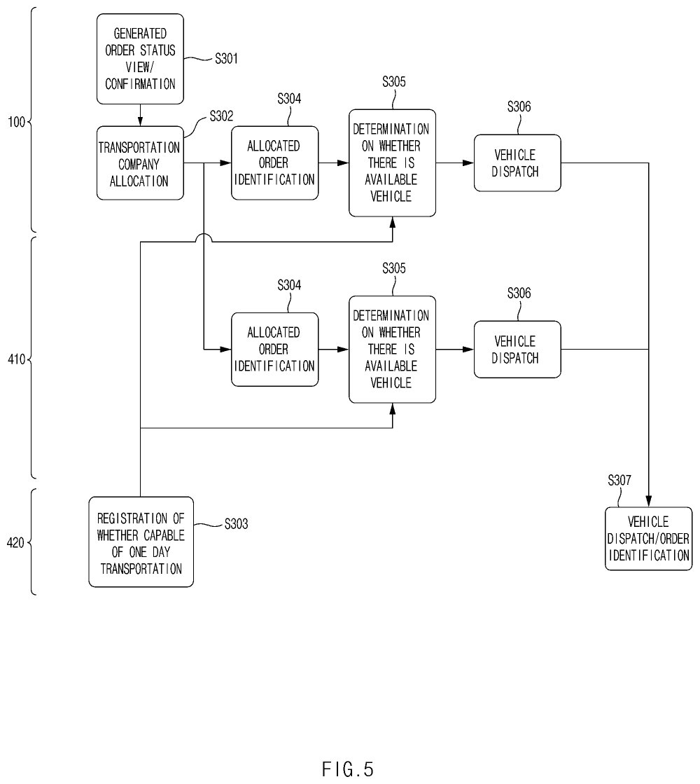

FIG. 5 is a view for illustrating a vehicle dispatch management operation of a fuel supply chain management system according to an embodiment disclosed in the present disclosure.

Referring to FIG. 5, the fuel supply chain management system 100 according to an embodiment disclosed in the present disclosure may generate the order information of the refueling station 200 as described in FIG. 4, and after allocating the shipping center 300 for the corresponding order, view the generated order information to confirm the corresponding order (S301).

In addition, the fuel supply chain management system 100 may allocate a transportation company 410 for transporting the tube trailer from the matching shipping center 300 to the refueling station 200 (S302). In this case, the fuel supply chain management system 100 may automatically allocate the transportation company 410 in consideration of sales, a travel distance, a location, and the like based on a past performance of each transportation company 410.

In addition, when the allocation of the transportation company 410 by the fuel supply chain management system 100 is completed, after determining whether a transportation vehicle driver 420 is able to perform the transportation, the transportation company 410 may register whether the transportation vehicle driver 420 is able to perform the transportation on a system of the transportation company 410 (S303) For example, the transportation company 410 may transmit a message for determining whether the transportation is possible to a terminal of the transportation vehicle driver 420, and then register whether the transportation is possible based on a reply of the transportation vehicle driver 420.

Next, when the allocation of the transportation vehicle driver 420 for the corresponding order is completed by the transportation company 410, the fuel supply chain management system 100 and the transportation company 410 may identify the corresponding allocated order (S304). In addition, after determining whether there is an available transportation vehicle (S305), the fuel supply chain management system 100 and the transportation company 410 may perform the vehicle dispatch on the vehicle capable of the transportation (S306). For example, the transportation vehicle may be automatically allocated in consideration of the sales, the travel distance, the number of transportation, and the like based on the past performance.

In addition, after the vehicle dispatch is completed, the fuel supply chain management system 100 or the transportation company 410 may transmit a vehicle dispatch and order identification message to the transportation vehicle driver 420 of the corresponding case (S307). For example, the vehicle dispatch and order identification message may be transmitted through an app stored in the terminal of the transportation vehicle driver 420 or, in a case of offline, may be delivered by printing a separate transportation instruction.

In one example, it has been described in FIG. 5 that the vehicle dispatch management operation of the fuel supply chain management system 100 is performed in communication with the transportation company 410, but the fuel supply chain management system 100 disclosed in the present disclosure is not limited thereto. It is also possible to perform the vehicle dispatch operation of the transportation company in the shipping center 300.

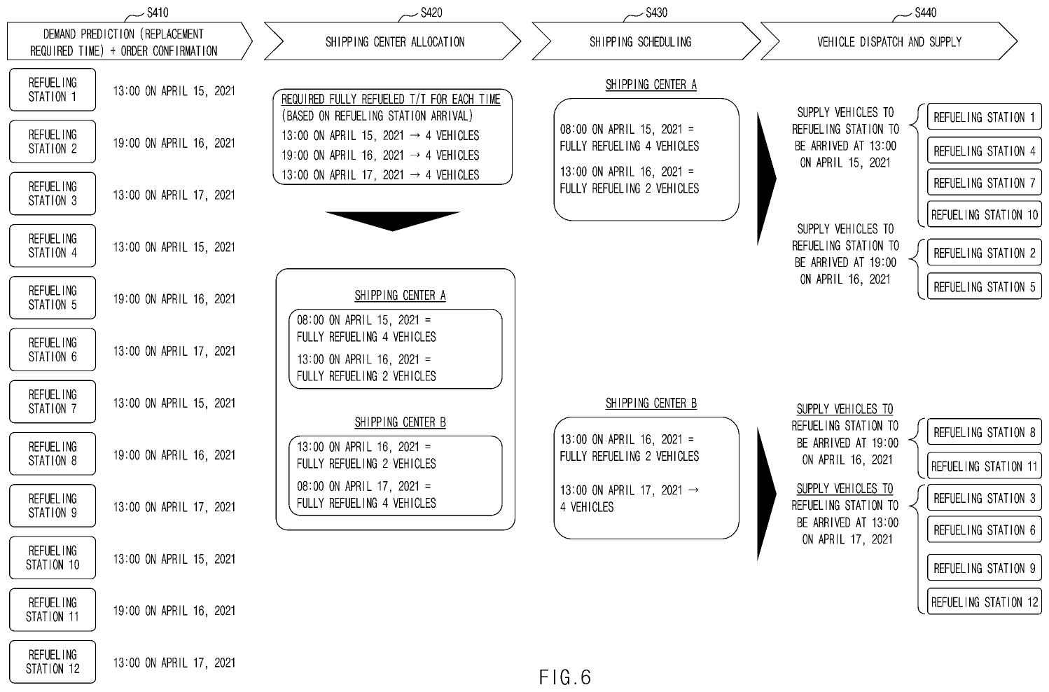

FIG. 6 is a view for illustratively describing a matching operation of a refueling station and a shipping center of a fuel supply chain management system according to an embodiment disclosed in the present disclosure.

Referring to FIG. 6, the fuel supply chain management system 100 according to an embodiment disclosed in the present disclosure may first predict the demand of each refueling station 200 to estimate the replacement required time, and confirm the order based on the corresponding demand prediction information (S410). For example, FIG. 6 shows replacement required date and time of each refueling station 200.

In addition, the fuel supply chain management system 100 may allocate the shipping center 300 based on the demand prediction and the replacement time of each refueling station 200 (S420). For example, in FIG. 6, based on a time the fully refueled tube trailer should arrive at the refueling station 200, 4 tube trailers are required for refueling stations 1, 4, 7, and 10 that need the replacement at 13:00 on 15 Apr. 2021, 4 tube trailers are required for refueling stations 2, 5, 8, and 11 that need the replacement at 19:00 on 16 Apr. 2021, and 4 tube trailers are required for refueling stations 3, 6, 9, and 12 that need the replacement at 13:00 on 17 Apr. 2021.

In addition, in the example of FIG. 6, for a shipping center A, the fuel supply chain management system 100 may fully refuel 4 tube trailers by 08:00 on Apr. 15, 2021 for the arrival at 13:00 on Apr. 15, 2021, and may fully refuel 2 tube trailers by 13:00 on Apr. 16, 2021 for the arrival at 19:00 on Apr. 16, 2021. In one example, for a shipping center B, the fuel supply chain management system 100 may fully refuel 2 tube trailers by 13:00 on Apr. 16, 2021 for the arrival at 19:00 on Apr. 16, 2021, and fully refuel 4 tube trailers by 08:00 on Apr. 17, 2021 for the arrival at 13:00 on Apr. 17, 2021.

In this connection, the fuel supply chain management system 100 may allocate the shipping center 300 in consideration of factors such as the number of recovered tube trailers, whether pre-refueling is possible, whether the shipping center 300 is close, the number of operatable nozzles in the shipping center 300 (including whether the nozzle is malfunctioning), and the like.

Next, the fuel supply chain management system 100 may perform the scheduling for the allocated shipping center 300 (S430). In this case, the fuel supply chain management system 100 may perform scheduling for the shipping center A such that the 4 tube trailers are fully refueled by 08:00 on Apr. 15, 2021, and the 2 tube trailers are fully refueled by 13:00 on Apr. 16, 2021. In addition, the fuel supply chain management system 100 may perform scheduling for the shipping center B such that the 2 tube trailers are fully refueled by 13:00 on Apr. 16, 2021, and the 4 tube trailers are fully refueled by 13:00 on Apr. 17, 2021.

For example, in operation S430, shipping scheduling may be performed in consideration of the operating hours of the refueling station 200, the distance to the shipping center 300, the average travel time of the transportation vehicle, a time it takes to fully refuel the tube trailer during simultaneous refueling at the shipping center 300, and the like. In addition, in operation S430, the shipment scheduling may be performed for each nozzle in consideration of a time required for the simultaneous refueling for fully refueling each tube trailer (e.g., 1 to 2 hours each).

In addition, the fuel supply chain management system 100 may dispatch the transportation vehicle to the allocated shipping center 300, and allow the transportation vehicle and the tube trailer to be supplied from the shipping center 300 to each matched refueling station 200 (S440). For example, in FIG. 6, for the shipping center A, the fuel supply chain management system 100 may dispatch the transportation vehicles to the refueling stations 1, 4, 7, and 10 to be arrived at 13:00 on Apr. 15, 2021 (vehicle dispatch at 8 am), and dispatch the transportation vehicles to the refueling stations 2 and 5 to be arrived at 19:00 on Apr. 16, 2021 (vehicle dispatch at 13:00 pm). In addition, for the shipping center B, the fuel supply chain management system 100 may dispatch the transportation vehicles to the refueling stations 8 and 11 to be arrived at 19:00 on Apr. 16, 2021 (vehicle dispatch at 13:00 pm), and dispatch the transportation vehicles to the refueling stations 3, 6, 9, and 12 to be arrived at 13:00 on Apr. 17, 2021 (vehicle dispatch at 8:00 am).

In one example, it has been described in FIGS. 1 to 6 above that the fuel to be refueled is the hydrogen, but the fuel supply chain management system 100 disclosed in the present disclosure may not be limited only to the fuel, and may perform supply chain management for various types of fuel.

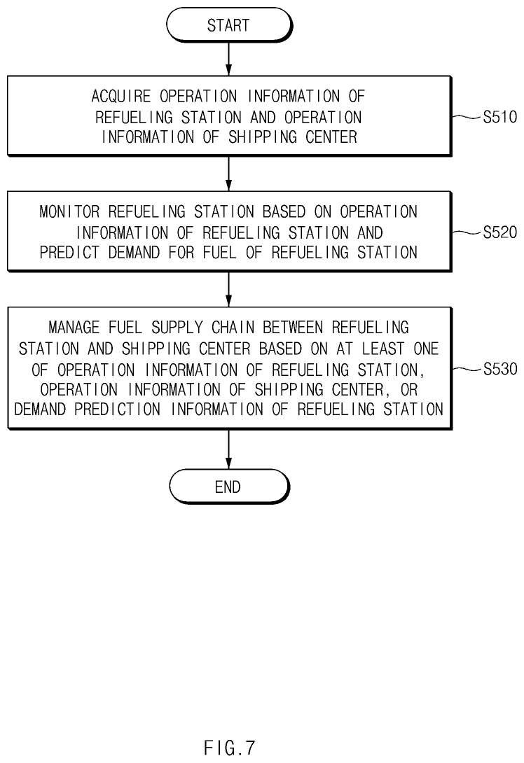

FIG. 7 is a flowchart showing a fuel supply chain management method according to an embodiment disclosed in the present disclosure.

Referring to FIG. 7, a fuel supply chain management method according to an embodiment disclosed in the present disclosure may acquire the operation information of the refueling station 200 and the operation information of the shipping center 300 first (S510). For example, the operation information of the refueling station 200 may include the usage of the fuel for each period, the remaining amount of the fuel, the fuel replacement history, the operating hours, the location information, and the like of the refueling station 200. In addition, the operation information of the shipping center 300 may include the supply amount for each period of the shipping center 300, the operation information on the transportation means of the fuel, the supply cycle of each refueling station 200, the location information, and the like of the shipping center 300. For example, the fuel may include the hydrogen in the form of the gas, the liquid, the LOHC, and the like.

Next, the monitoring on the refueling station 200 may be performed based on the operation information of the refueling station 200, and the demand for the fuel provided by the refueling station 200 may be predicted (S520). Specifically, in operation S520, the demand for the fuel of the refueling station 200 may be predicted based on the consumption pattern of the fuel of the refueling station 200, in addition, in operation S520, the information on the vehicle dispatch status of the transportation means for transporting the fuel, the real-time location of the transportation means, and the expected arrival time of the transportation means may be provided to the refueling station.

In one example, in operation S520, the order information on the transportation of the fuel may also be automatically generated based on the demand prediction information on the fuel of the refueling station 200. That is, in the fuel supply chain management method according to an embodiment disclosed in the present disclosure, the replacement time and the quantity may be estimated based on the demand prediction information calculated based on the fuel usage, the remaining amount, and the like of the refueling station 200, and the automatic order may be performed even when the operator of the refueling station 200 does not place the order by himself.

Next, the fuel supply chain between the refueling station 200 and the shipping center 300 may be managed based on at least one of the operation information of the refueling station 200, the operation information of the shipping center 300, or the demand prediction information of the refueling station 200 (S530). For example, the shipping center 300 capable of transporting the fuel to each refueling station 200 may be allocated based on the operation information of the refueling station 200, the operation information of the shipping center 300, and the demand prediction information of the refueling station 200.

In addition, in operation S530, the schedule on the transportation of the fuel may be created. In this connection, the schedule on the transportation of the fuel may include the information on the allocation and the vehicle dispatch schedules of the transportation means for transporting the fuel. For example, the fuel transportation schedule may be created based on the information on the supply amount of the fuel of the shipping center 300, the number of refueling nozzles equipped in the shipping center 300, the pressure of the refueling nozzle, the number of fuel transportation means, and the capacity of the transportation means, and the information on the operating hours, the distance to the shipping center 300, and the average travel time to the shipping center 300 of the refueling station 200.

In addition, in operation S530, the refueling schedule information on the transportation means of the fuel equipped in the shipping center 300 may be created. Accordingly, the manager of the shipping center 300 may be allowed to perform the refueling of the transportation means (e.g., the tube trailer) based on the refueling schedule information.

In one example, operation S530 may further include providing the information on the consumption, the remaining amount, the demand prediction, the replacement time, and the like of the fuel of each refueling station 200 to the shipping center 300. In addition, operation S530 may further include providing the information on the travel route of the transportation means calculated based on the real-time traffic information to the shipping center 300. In addition, operation S530 may further include performing the monitoring on the refueling state of the transportation means of the fuel equipped in the shipping center 300.

In addition, in operation S530, the settlement information on the transportation of the fuel may be generated based on the actual transportation information of the fuel. For example, the settlement information that includes the supply amount of the fuel, the transportation means usage fee, and the like, and is about the corresponding transportation case may be generated.

As such, the fuel supply chain management method according to an embodiment disclosed in the present disclosure monitors the entire region of the hydrogen supply chain and implements the optimized system through the optimal logic application, thereby monitoring the consumption, the supply cycle, the remaining amount, the demand prediction, and the like of the refueling, station 200 in real time, performing the stable operation and the supply and demand management with the easy access to the transportation information, and performing the efficient refueling and vehicle dispatch tasks based on the information such as the consumption, the demand prediction, and the operation status of the tube trailers, and the like of each refueling station 200.

Even though all components constituting the embodiment disclosed in the present disclosure have been described above as being coupled to be one component or operated in combination, the embodiments disclosed in the present disclosure are not necessarily limited to such embodiment. That is, as long as it is within the scope of the objectives of the embodiments disclosed in the present disclosure, the components may operate by being selectively coupled to each other to be one or more components.

In addition, terms such as “include”, “constitute”, or “have” described above mean that the corresponding component may be inherent, unless otherwise stated, so that it should not be construed as excluding other components, but may further include other components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

1. A system for managing a fuel supply chain, the system comprising:
an information acquisition device configured to acquire operation information of a refueling station and operation information of a shipping center;
a refueling station management device configured to monitor the refueling station based on the operation information of the refueling station, and predict a demand for fuel provided by the refueling station; and
a shipment management device configured to manage the fuel supply chain between the refueling station and the shipping center based on at least one of the operation information of the refueling station, the operation information of the shipping center, or demand prediction information of the refueling station.

2. The system of claim 1, wherein the refueling station management device is configured to predict the demand for the fuel of the refueling station based on a consumption pattern for the fuel of the refueling station.

3. The system of claim 1, wherein the refueling station management device is configured to provide at least one of information on a vehicle dispatch status of transportation means for transporting the fuel, a renal-time location of the transportation means, or an expected arrival time of the transportation means to the refueling station.

4. The system of claim 1, wherein the refueling station management device is configured to automatically generate order information on transportation of the fuel based on the demand prediction information on the fuel of the refueling station.

5. The system of claim 1, wherein the shipment management device is configured to allocate a shipping center capable of transporting the fuel to each refueling station based on the operation information of the refueling station, the operation information of the shipping center, and the demand prediction information of the refueling: station.

6. The system of claim 1, wherein the shipment management device is configured to create a schedule for transportation of the fuel.

7. The system of claim 6, wherein the schedule for the transportation of the fuel includes information on allocation and vehicle dispatch schedules of transportation means for transporting the fuel.

8. The system of claim 1, wherein the shipment management device is configured to generate refueling schedule information on transportation means of the fuel equipped in the shipping center.

9. The system of claim 1, wherein the shipment management device is configured to provide information on at least one of a consumption, a remaining amount, a demand prediction, or a replacement time of the fuel of each refueling station to the shipping center.

10. The system of claim 1, wherein the shipment management device is configured to generate settlement information on transportation of the fuel based on actual transportation information of the fuel.

11. The system of claim 1, wherein the shipment management device is configured to provide information on a travel route of transportation means for transporting the fuel calculated based on real-time traffic information to the shipping center.

12. The system of claim 1, wherein the shipment management device is configured to perform monitoring on a refueling state of transportation means of the fuel equipped in the shipping center.

13. The system of claim 1, wherein the operation information of the refueling station includes at least one of a usage of the fuel for each period, a remaining amount of the fuel, a replacement history of the fuel, operating hours, or location information of the refueling station.

14. The system of claim 1, wherein the operation information of the shipping center includes at least one of a supply amount for each period of the shipping center, operation information on transportation means of the fuel, a supply cycle of each refueling station, or location information of the shipping center.

15. The system of claim 1, wherein the shipment management device is configured to create a transportation schedule based on information on a supply amount of the fuel of the shipping center, the number of refueling nozzles equipped in the shipping center, a pressure of the refueling nozzle, the number of fuel transportation means, and a capacity of transportation means, and information on operating hours, a distance to the shipping center, and an average travel time to the shipping center of the refueling station.

16. The system of claim 1, wherein the fuel includes hydrogen in a form of at least one of gas, liquid, or liquid organic hydrogen carriers (LOHC).

11. A system for managing a fuel supply chain, the system comprising:
acquiring operation information of a refueling station and operation information of a shipping center;
monitoring the refueling station based on the operation information of the refueling station, and predicting a demand for fuel provided by the refueling station; and
managing the fuel supply chain between the refueling station and the shipping center based on at least one of the operation information of the refueling station, the operation information of the shipping center, or demand prediction information of the refueling station.
